(19) United States
(12) Patent Application Publication
(10) Pub. No.: US 2016/0109952 A1
(43) Pub. Date: Apr. 21, 2016

(54) Method of Controlling Operating Interface of Display Device by User's Motion

(71) Applicant: Top Victory Investments Ltd., Kowloon (HK)

(72) Inventor: Tim Wu, New Taipei City (TW)

(21) Appl. No.: 14/516,642

(22) Filed: Oct. 17, 2014

(51) Int. Cl. G06F 3/01; G06F 3/0484

(52) U.S. Cl. CPC G06F 3/017; G06F 3/04842

(57) ABSTRACT

The invention relates to a method of controlling an operating interface of a display device by user's motion. The operating interface is displayed on a screen. The operating interface comprises columns extending along a horizontal direction and layers extending along a depth direction. The method comprises steps of: displaying the operating interface on the screen of the display device; detecting the user's motion by the display device; moving a hand to an initial position by the user; and corresponding the user's motion to the operating interface by the display device. When the user moves the hand left or right or rotates the eyes left or right along the horizontal direction of the screen, the operating interface accordingly switches the columns left or right. When the user moves the hand forward or backward along the depth direction of the screen, the operating interface accordingly switches the layers forward or backward.

### BACKGROUND OF THE INVENTION

1. Field of the Invention

The present invention relates to a method of controlling a display device by a user, and, more particularly, to a method of controlling an operating interface of a display device by a user's motion.

2. Description of the Prior Art

A smart TV usually provides users an operating interface for complex operation. For example, several channels are presented in the operating interface, and one of the channels users want to watch can be chosen. Then a chosen channel can be displayed on a screen of the display device in a full screen mode. Regarding the limitation of the size of the screen, presenting all channels on the operating interface at the same time is not reasonable. A prior method about how the channels can be presented has been presented, the method is that the channels are aligned as columns extending along a horizontal direction relating to the screen and layers extending along a depth direction relating to the screen, and the channels can be chosen by a specific remote device. For example, the user can use direction buttons of a TV's remote control to switch the layers and the columns. Since the method requires a remote control, it is inconvenient in a situation that either the remote control's battery is dead or the remote control is not beside the user.

### SUMMARY OF THE INVENTION

According to the disadvantage of the prior art, the present invention aims to provide a method of controlling an operating interface of a display device by user's motion. The display device is utilized for detecting user's motion and corresponding user's motion to the operating interface for switching and choosing columns and layers, so as to improve convenience of controlling the operating interface.

According to the claimed invention, the operating interface is utilized for being displayed on a screen of the display device, the operating interface comprises a plurality of columns extending along a horizontal direction relating to the screen and a plurality of layers extending along a depth direction relating to the screen, and the method of controlling the operating interface of the display device by the user's motion comprises steps of: displaying the operating interface on the screen of the display device; detecting the user's motion by the display device; moving a hand to an initial position by the user; and corresponding the user's motion to the operating interface by the display device. When the user moves the hand left or right or rotates the eyes left or right along the horizontal direction of the screen, the operating interface accordingly switches the columns left or right. When the user moves the hand forward or backward along the depth direction of the screen, the operating interface accordingly switches the layers forward or backward.

The method of controlling the operating interface of the display device by the user's motion utilizes the display device to detect user's motion and then to correspond the user's motion to the operating interface for switching and choosing columns and layers. The convenience of controlling the operating interface is improved by the method.

### BRIEF DESCRIPTION OF THE DRAWINGS

FIG. 1 is a flowchart of a method of controlling an operating interface of a display device by user's motion according to a preferred embodiment of the present invention.

FIG. 2 is a diagram of a hand of the user and the display device according to the preferred embodiment of the present invention.

FIG. 3 is the first diagram of the method of controlling the operating interface of the display device by the user's motion according to the preferred embodiment of the present invention.

FIG. 4 is the second diagram of the method of controlling the operating interface of the display device by the user's motion according to the preferred embodiment of the present invention.

FIG. 5 is the third diagram of the method of controlling the operating interface of the display device by the user's motion according to the preferred embodiment of the present invention.

FIG. 6 is the fourth diagram of the method of controlling the operating interface of the display device by the user's motion according to the preferred embodiment of the present invention.

FIG. 7 is a block diagram of the display device according to the preferred embodiment of the present invention.

### DETAILED DESCRIPTION

In embodiments below, same or similar reference characters represent the same or similar components. In addition, directional terms described in the embodiments are merely used for reference and illustration according to the drawings; therefore, the directional terms shall not limit the scope of the invention.

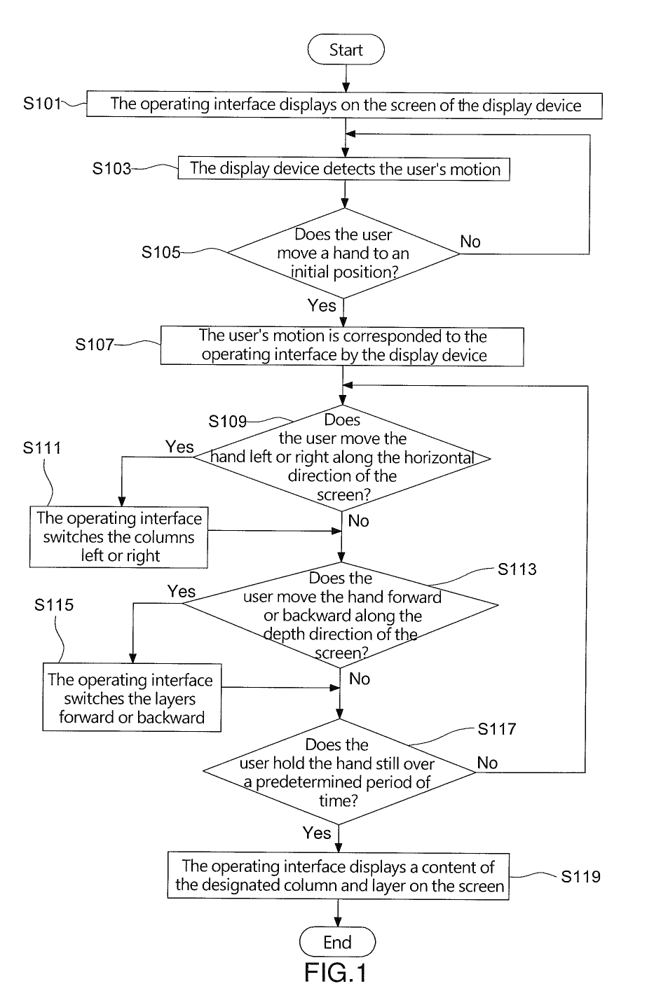

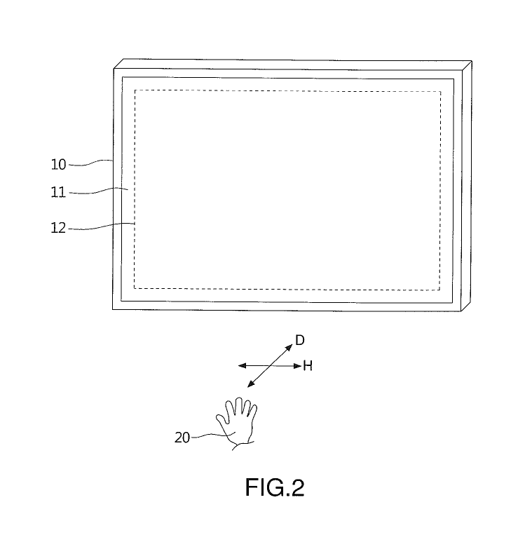

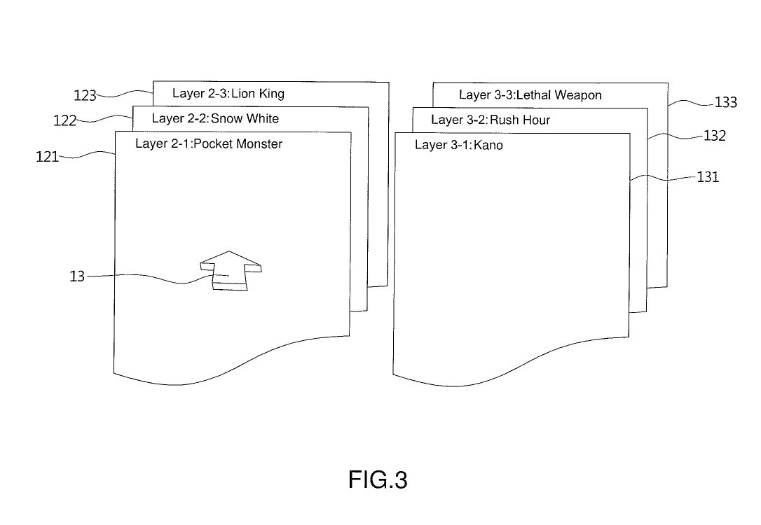

Referring to FIG. 1, FIG. 2, and FIG. 3, FIG. 1 depicts a flowchart of a method of controlling an operating interface 12 of a display device 10 by user's motion according to a preferred embodiment of the present invention. FIG. 2 depicts a diagram of a hand 20 of the user and the display device 10 according to the preferred embodiment of the present invention. FIG. 3 depicts the first diagram of the method of controlling the operating interface 12 of the display device 10 by the user's motion according to the preferred embodiment of the present invention. The method of the preferred embodiment is applied to, but is not limited to, a smart TV. As shown in FIG. 2, the display device 10 comprises a screen 11. The operating interface 12 of the display device 10 is displayed on the screen 11. A user who wants to control the operating interface 12 of the display device 10 stands in front of the display device 10. The position of the user is represented by the hand 20 shown in FIG. 2. As shown in FIG. 2 and FIG. 3, the operating interface 12 comprises a plurality of columns extending along a horizontal direction H relating to the screen 11 and a plurality of layers extending along a depth direction D relating to the screen 11. In the embodiment, the display device 10 is a flat TV; in other embodiments, the display device can be a 3D TV with or without glasses.

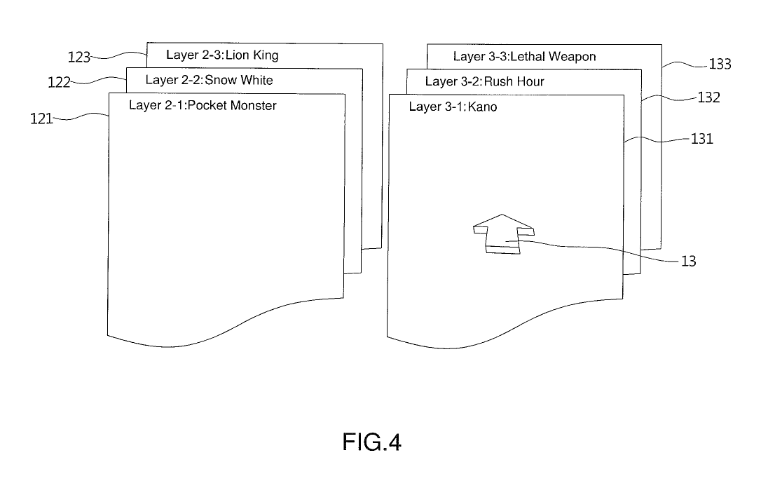

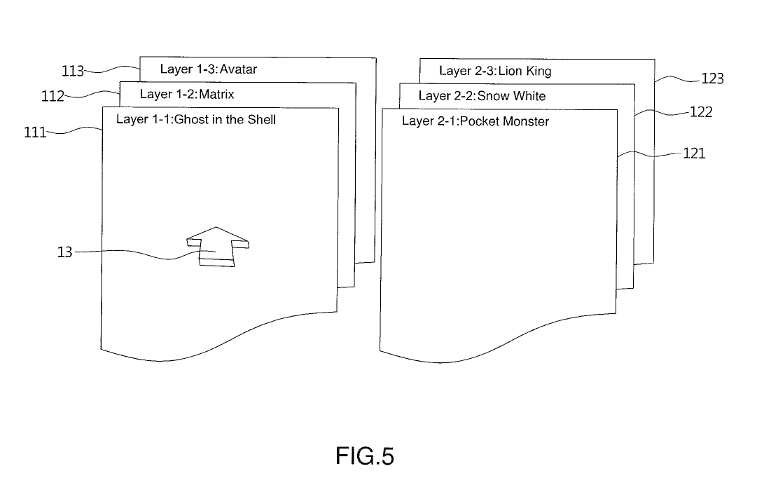

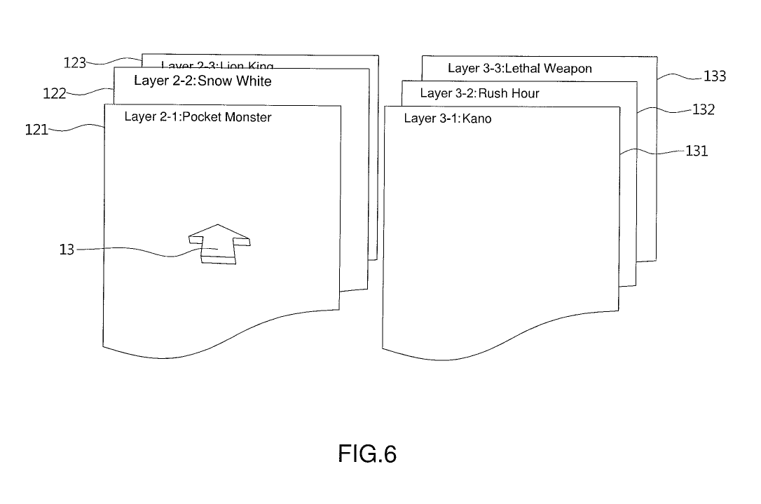

Referring to FIG. 3 to FIG. 6, FIG. 4, FIG. 5, and FIG. 6 respectively depict the second, the third, and the fourth diagrams of controlling the operating interface 12 of the display device 10 by the user's motion. In the embodiment, all layers extending along the depth direction D are displayed on the screen 11 at the same time, two columns extending along the horizontal direction H are displayed on the screen 11 side by side, and the other columns out of the boundary of the screen 11 are hidden. For example, the first column and the first layer 111, the first column and the second layer 112, and the first column and the third layer 113 shown in FIG. 5 are hidden in FIG. 3, because the first column and the first layer 111, the first column and the second layer 112, and the first column and the third layer 113 are located at left of the second column and the first layer 121, the second column and the second layer 122, and the second column and the third layer 123 in the virtual space, and are out of the range of the screen 11 for displaying. Wherein, each layer comprises a tag. For example, a tag of the second column and the first layer 121 shows “Pocket Monster”, a tag of the second column and the second layer 122 shows “Snow White”, a tag of the third column and the first layer 131 shows “Kano”, and a tag of the third column and the second layer 132 shows “Rush hour”. Information shown on each tag represents relative contents of a designated column and layer to which a tag belong. The tags belonging to the same column partly overlay each other. The reason that the tags of the same column do not fully overlay each other is to show each tag of each layer of each column in the depth direction D on the screen 11. In the embodiment, layers belonging to the same column have films with the same classification or attribute. For example, films of the first column and the first layer 111 to the first column and the third layer 113 belong to Sci-Fi films, films of the second column and the first layer 121 to the second column and the third layer 123 belong to animations, and films of the third column and the first layer 131 to the third column and the third layer 133 belong to action films.

As shown in FIG. 1, the method of controlling the operating interface 12 of the display device 10 by the user's motion comprises steps as follows. In step S101, the user turns on the display device 10 and executes the operating interface 12, and the operating interface 12 of the display device 10 displays on the screen 11. In step S103, the display device 10 begins to continuously detect the user's motion. For example, the display device 10 detects position of the user and motion of face or of limbs of the user to identify whether the user is going to control the operating interface 12 by motion or not. The display device 10 can detect the user's motion by a camera. For example, the display device 10 comprises built-in dual cameras or connects to dual cameras established outside (not shown in figures), and the dual cameras can take images for processing 3D matrix calculation to derive position of the user and motion of the hand 20 in 3D space.

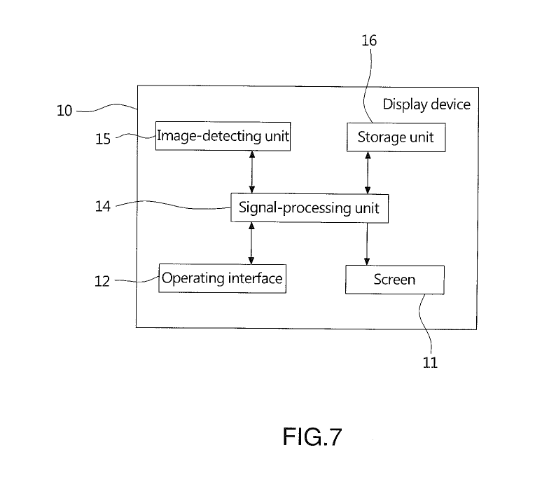

Referring to FIG. 7, FIG. 7 is a block diagram of the display device 10 according to the preferred embodiment of the present invention. In addition to the screen 11 and the operating interface 12, the display device 10 further comprises a signal-processing unit 14, an image-detecting unit 15, and a storage unit 16 in the embodiment. The image-detecting unit 15, i.e. the built-in dual cameras, is in the display device 10. Images detected by the image-detecting unit 15 can be transmitted to the signal-processing unit 14. And the signal-processing unit 14 and the storage unit 16 can cooperate with each other to process 3D matrix calculation and can further correspond the user's motion to the operating interface 12 displayed on the screen 11. In other embodiments, the display device can detect the user's motion by ultrasonic. Alternatively, the display device can detect the user's motion by a camera or a sensor of a portable device in a wireless manner. The portable device can be a smart phone, a tablet, or a smart glass. Taking the tablet for example, the tablet comprises a screen and dual cameras disposed on the side of the screen. The user can put the tablet beside him, and the user's motion can be detected in form of stereo images taken by the dual cameras of the tablet. Then the images can be analyzed and be wirelessly transmitted to the display device. Taking the smart phone for example, the user can directly hold the smart phone, and the hand's motion can be detected by a built-in G sensor of the smart phone and be wirelessly transmitted to the display device.

In the step S105, the display device 10 continuously detects the user's motion to identify if the user moves the hand 20 to an initial position. If not, step S103 will be continuously processed; if so, step S107 will be processed. In the embodiment, the initial position is defined as a relative position between the user's hand 20 and the user's body, and more specifically, the initial position is defined as a motion and a position that the hand 20 is closing to and ends up near the user's chest. In other words, when the user raises his hand 20 and the hand 20 ends up near his chest, the display device 10 will confirm that the user has already moved the hand 20 to the initial position. In other embodiment, the initial position can be defined as a position and a direction of a palm of the user's hand. When the user spreads the hand and makes the palm facing the display device, the display device will confirm that the user has already moved the hand to the initial position and will process step S107.

In step S107, the motion of the user's hand 20 is corresponded to the operating interface 12 by the display device 10; meanwhile, the motion of the hand 20 can control the operating interface 12. In other embodiment, rotation of the user's eyes can also be corresponded to the operating interface, such that the eyes' rotation can control the operating interface. In step S109, the display device 10 detects and identifies if the user moves the hand 20 left or right along the horizontal direction H of the screen 11. If not, step S113 will be directly processed; if so, step S111 will be processed prior to step S113. As shown in FIG. 2, the horizontal direction H is a direction parallel to the screen 11. In step S111, when the user moves the hand 20 left or right along the horizontal direction H of the screen 11, the operating interface 12 accordingly switches the columns left or right in sequence. As shown in FIG. 3, an arrow 13 of the operating interface 12 points the second column and the first layer 121, meaning that the second column and the first layer 121 is a corresponding column and layer now. When the user moves the hand 20 forward, a corresponding column and layer will be switched from the second column and the first layer 121 to the second column and the second layer 122. If the user moves the hand 20 backward then, the corresponding column and layer will be switched back to the second column and the first layer 121. In the embodiment, switching between the layers substantially switches, but is not limited to, between the tags of the layers. A tag to which is switched produces a special effect. The special effect comprises a bouncing, a shifting, a highlighting, or an enlarging. In the embodiment, if the switched tag is the second column and the second layer 122, as shown in FIG. 6, the tag of the second column and the second layer 122 will slightly enlarge and partly overlay the text of the tag of the second column and the third layer 123 to emphasize that the second column and the second layer 122 is been switched to.

In step S117, the display device 10 detects and identifies if the user holds the hand 20 still over a predetermined period of time. Wherein, the predetermined period of time is, for example, three seconds. If not, step S109 to step S117 will be repeated since the user has not decided what he wants to choose; if so, step S119 will be processed since the user has decided what he wants to choose. Taking FIG. 6 for example, if “Snow White” of the second column and the second layer 122 is just what the user want to choose, the user could hold the hand 20 still over three seconds, such that the display device 10 can confirm that “Snow White” is what the user want to choose. In other embodiment, manners of identifying if the user decides what he wants to choose in step S117 can be alternative. For example, if the display device begins to corresponding the user's motion to the operating interface under the circumstance that the initial position is that the user spreads the hand and makes the palm facing the display device, the display device can identify whether the user decides what he wants to choose or not by identifying if the user fists his hand. If the user fists the hand which controls the operating interface, meaning that the user has decided what he wants to choose, the display device will detect that the hand is fisted and step S119 will be processed. Alternatively, the display device can identify if the user decides what he wants to choose by detecting the movement of specific fingers of the user's hand. For example, if the user folds and attaches the index finger, the middle finger, the ring finger, and the little finger of the hand to the palm and extends the thumb, or the users only folds the thumb and extents the other four fingers, the display device will identify that the user has decided what he wants to choose. In step S119, the operating interface 12 confirms a designated column and layer the user decides and displays a content of the designated column and layer on the screen 11. Taking FIG. 6 for example, the display device 10 will display a content of the second column and the second layer 122 on the screen 11 in a full screen mode. In other words, the display device 10 will begin to play “Snow White”.

In other embodiment, if there are several people, including a real user, staying in front of the display device, the real user can be identified by recognizing fingerprints or palm prints by the display device. For example, images of hands can be taken by the camera, and then the fingerprint or the palm print of the user previously registered in the system of the display device can be recognized by a built-in image recognizing software of the display device, and the motion of the user who is identified by the display device will be correspond to the operating interface, and the motion of the other people who are not users are excluded; therefore, interference can be avoided when the user controls the operating interface. In addition, to avoid interference, like limbs of other people who are not the real user or objects, the display device can be utilized for analyzing a skeleton structure from images taken by the cameras to exclude unreasonable parts which don't belong to the user; therefore, the motion of the user can be accurately corresponded to the operating device. The skeleton structure, for example, is a simulated human body structure which is consisted of the head, the torso, the limbs, and the articulations and is represented by combination of lines. When the user's hand holds an artificial hand, the motion of the artificial hand is excluded by the display device and does not interfere with the process of controlling the operating interface, since the artificial hand is identified as a redundant structure, an unreasonable part, in the skeleton structure by the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling an operating interface of a display device by user's motion, the operating interface utilized for being displayed on a screen of the display device, the operating interface comprising a plurality of columns extending along a horizontal direction relating to the screen and a plurality of layers extending along a depth direction relating to the screen, and the method of controlling the operating interface of the display device by the user's motion comprising:
displaying the operating interface on the screen of the display device;
detecting the user's motion by the display device;
moving a hand to an initial position by the user; and
corresponding the user's motion to the operating interface by the display device;
when the user moves the hand forward or backward along the depth direction of the screen, the operating interface accordingly switches the layers forward or backward.

2. The method of controlling the operating interface of the display device by the user's motion of claim 1, wherein the step of corresponding the user's motion to the operating interface by the display device further comprises:
when the user moves the hand left or right along the horizontal direction of the screen, the operating interface accordingly switches the columns left or right.

3. The method of controlling the operating interface of the display device by the user's motion of claim 2, wherein the step of corresponding the user's motion to the operating interface by the display device further comprises:
switching the operating interface to a designated column and layer; and
holding the hand still over a predetermined period of time;
after the display device detects that the hand is held still over the predetermined period of time, the operating interface confirms that the designated column and layer are chosen and displays a content of the designated column and layer on the screen.

4. The method of controlling the operating interface of the display device by the user's motion of claim 2, wherein the step of moving the hand to the initial position by the user and corresponding the user's motion to the operating interface by the display device further comprises:
spreading the hand and facing a palm of the hand to the display device;
after the display device detects that the palm is faced to the display device, the display device corresponds the user's motion to the operating interface.

5. The method of controlling the operating interface of the display device by the user's motion of claim 4, wherein the step of corresponding the user's motion to the operating interface by the display device further comprises:
switching the operating interface to a designated column and layer; and
fisting the hand;
after the display device detects that the hand of the user is fisted, the operating interface confirms that the designated column and layer are chosen and displays a content of the designated column and layer on the screen.

6. The method of controlling the operating interface of the display device by the user's motion of claim 4, wherein the step of corresponding the user's motion to the operating interface by the display device further comprises:
switching the operating interface to a designated column and layer; and
folding specific fingers of the hand by the user;
after the display device detects that the specific fingers are folded, the operating interface confirms that the designated column and layer are chosen and displays a content of the designated column and layer on the screen.

7. The method of controlling the operating interface of the display device by the user's motion of claim 3, wherein the operating interface confirms that the designated column and layer are chosen and displays the content of the designated column and layer on the screen in a full screen mode.

8. The method of controlling the operating interface of the display device by the user's motion of claim 5, wherein the operating interface confirms that the designated column and layer are chosen and displays the content of the designated column and layer on the screen in a full screen mode.

9. The method of controlling the operating interface of the display device by the user's motion of claim 6, wherein the operating interface confirms that the designated column and layer are chosen and displays the content of the designated column and layer on the screen in a full screen mode.

10. The method of controlling the operating interface of the display device by the user's motion of claim 1, wherein the step of corresponding the user's motion to the operating interface by the display device further comprises:
when the user rotates eyes left or right along the horizontal direction of the screen, the operating interface accordingly switches the columns left or right.

11. The method of controlling the operating interface of the display device by the user's motion of claim 10, wherein the step of corresponding the user's motion to the operating interface by the display device further comprises:
switching the operating interface to a designated column and layer; and
holding the hand still over a predetermined period of time;
after the display device detects that the hand is held still over the predetermined period of time, the operating interface confirms that the designated column and layer are chosen and displays a content of the designated column and layer on the screen.

12. The method of controlling the operating interface of the display device by the user's motion of claim 10, wherein the step of moving the hand to the initial position by the user and corresponding the user's motion to the operating interface by the display device further comprises:
spreading the hand and facing a palm of the hand to the display device;
after the display device detects that the palm is faced to the display device, the display device corresponds the user's motion to the operating interface.

13. The method of controlling the operating interface of the display device by the user's motion of claim 12, wherein the step of corresponding the user's motion to the operating interface by the display device further comprises:
switching the operating interface to a designated column and layer; and
fisting the hand;
after the display device detects that the hand of the user is fisted, the operating interface confirms that the designated column and layer are chosen and displays a content of the designated column and layer on the screen.

14. The method of controlling the operating interface of the display device by the user's motion of claim 12, wherein the step of corresponding the user's motion to the operating interface by the display device further comprises:
switching the operating interface to a designated column and layer; and
folding specific fingers of the hand by the user;
after the display device detects that the specific fingers are folded, the operating interface confirms that the designated column and layer are chosen and displays a content of the designated column and layer on the screen.

15. The method of controlling the operating interface of the display device by the user's motion of claim 11, wherein the operating interface confirms that the designated column and layer are chosen and displays the content of the designated column and layer on the screen in a full screen mode.

16. The method of controlling the operating interface of the display device by the user's motion of claim 13, wherein the operating interface confirms that the designated column and layer are chosen and displays the content of the designated column and layer on the screen in a full screen mode.

17. The method of controlling the operating interface of the display device by the user's motion of claim 14, wherein the operating interface confirms that the designated column and layer are chosen and displays the content of the designated column and layer on the screen in a full screen mode.

18. The method of controlling the operating interface of the display device by the user's motion of claim 1, wherein the step of that when the user moves the hand forward or backward along the depth direction of the screen, the operating interface accordingly switches the layers forward or backward further comprises:
displaying the plurality of layers extending along the depth direction on the screen, wherein each layer comprises a tag and the tags partly overlay each other;
when the user moves the hand forward or backward along the depth direction of the screen, the operating interface accordingly switches the tags in sequence;
wherein, a tag to which is switched produces a special effect, and the special effect comprises a bouncing, a shifting, a highlighting, or an enlarging.

19. The method of controlling the operating interface of the display device by the user's motion of claim 1, wherein the step of corresponding the user's motion to the operating interface by the display device further comprises:
recognizing a fingerprint or a palm print of the user by the display device; and
analyzing a skeleton structure of the user by the display device.

20. The method of controlling the operating interface of the display device by the user's motion of claim 1, wherein the display device detects the user's motion by a camera on the display device, an ultrasound device on the display device, a camera on a portable device wirelessly connecting the display device, or a G sensor on the portable device.
